(19) United States
(12) Patent Application Publication
(10) Pub. No.: US 2014/0180725 A1
(43) Pub. Date: Jun. 26, 2014

(54) SYSTEMS, METHODS, AND APPARATUS FOR FACILITATING VERIFICATION OF INSURANCE INFORMATION VIA A GAME SYSTEM

(71) Applicant: THE TRAVELERS INDEMNITY COMPANY, Hartford, CT (US)

(72) Inventors: Hoa Ton-That, South Glastonbury, CT (US); Edward A. Charlebois, Tolland, CT (US)

(73) Assignee: THE TRAVELERS INDEMNITY COMPANY, Hartford, CT (US)

(21) Appl. No.: 13/725,106

(22) Filed: Dec. 21, 2012

(51) Int. Cl. G06Q 40/08

(52) U.S. Cl. CPC G06Q 40/08
USPC 705/4

(57) ABSTRACT

Systems, apparatus, methods, and articles of manufacture provide for facilitating verification of insurance information via a game system. Some embodiments provide for rewarding a customer with a game reward (e.g., points, in-game content) in exchange for the customer submitting, via a mobile device, a digital image of a customer activity or other information related to an insurance product.

### BACKGROUND

An insurance policy protects a policy owner against contingent losses, such as property loss, property damage, bodily injury, and death, for example. In one example, homeowner's insurance may protect a home owner against losses resulting from damage to a home, loss of a home's contents, or accidents occurring at the home. In another example, automobile insurance may protect an automobile owner against losses resulting from auto accidents.

To obtain insurance, a customer (e.g., an individual or other client) pays an insurer a premium and, in return, the insurer agrees to pay losses that the customer incurs, as defined in the terms of an insurance policy. The amount of the premium may be determined based on various factors. For example, a personal insurance premium may be based on the age, gender, credit rating, and home address of an insured. In some cases, insurance companies may set or adjust automobile insurance premiums based on information about the subject of the coverage (e.g., information about the home or automobile being insured, information about one or more users of the insured property).

### BRIEF DESCRIPTION OF THE DRAWINGS

An understanding of embodiments described in this disclosure and many of the attendant advantages may be readily obtained by reference to the following detailed description when considered with the accompanying drawings, of which:

FIG. 1A is a diagram of a system according to some embodiments;

FIG. 1B is a diagram of a system according to some embodiments;

FIG. 2 is a diagram of a computing device according to some embodiments;

FIG. 3 is a diagram of a mobile device according to some embodiments;

FIG. 4 is a diagram of a mobile device according to some embodiments;

FIG. 5 is a flowchart of a method according to some embodiments;

FIG. 6 is a flowchart of a method according to some embodiments;

FIG. 7 is a diagram of an example user interface according to some embodiments;

FIG. 8A is a diagram of an example policy booklet according to some embodiments;

FIG. 8B is a diagram of an example policy booklet according to some embodiments;

FIG. 9A is a diagram of an example user interface according to some embodiments;

FIG. 9B is a diagram of an example user interface according to some embodiments;

FIG. 10A is a diagram of an example user interface according to some embodiments;

FIG. 10B is a diagram of an example user interface according to some embodiments;

FIG. 10C is a diagram of an example user interface according to some embodiments;

FIG. 11A is a diagram of an example user interface according to some embodiments;

FIG. 11B is a diagram of an example user interface according to some embodiments; and

FIG. 11C is a diagram of an example user interface according to some embodiments.

### DETAILED DESCRIPTION

This disclosure relates generally to systems, apparatus, media, and methods for facilitating documentation of insurance information. In particular, this disclosure relates to systems, apparatus, media, and methods for promoting, using a game reward system, the providing by customers of customer information relating to the subject(s) of existing insurance policies and/or potential insurance policy coverage. In some embodiments, customer data items related to an insurance policy, the insured property (e.g., the use and/or current state of a customer's home, vehicle, possessions, and/or other personal property), users of the property, beneficiaries of the insurance policy, and/or potential claimants, may be recorded and/or transmitted to an insurance company by a customer, in exchange for and/or to progress toward of one or more game rewards (e.g., a number of points toward a predetermined points goal corresponding to a prize for the customer).

Applicants have recognized that, in accordance with some embodiments described in this disclosure, some types of insurers may find it beneficial to determine an insurance premium and/or determine a game reward for a customer based on information provided to the insurer in a game context by the customer, in which the information relates to the subject of a current and/or potential insurance policy.

Applicants further have recognized that, in accordance with some embodiments described in this disclosure, some types of insurers may find it beneficial to receive information from a customer, in which the information relates to the subject of a current and/or potential insurance policy (e.g., a digital picture of insured property), and to provide a game reward to the customer for providing the information, in which the game reward does not include an adjustment to an insurance premium and is provided alone or in addition to any adjustment of insurance premium based on the information.

In some embodiments, an insurer may determine an insurance premium based on values associated with the customer-provided data items, alone or in conjunction with other data. In addition, the customer may select which data items to record and/or transmit in order to receive and/or pursue a game reward. An insurance policy may or may not be updated (e.g., policy pricing, discounts, surcharges, and/or associated benefits or penalties) by an insurer in response to receiving a customer-provided data item.

Applicants have further recognized that some types of insurers may find it beneficial to provide a game experience via an application (e.g., a smartphone, tablet computer, and/or web-based app) that encourages a customer to document with the insurer key events related to an insurance policy, increases engagement of a customer with an insurer and/or the customer's insurance policy, and/or motivates the customer to make proactive behavior changes (e.g., to protect the customer's assets, to reduce risk of property loss). In some embodiments, a customer may be encouraged (e.g., via a game system) to document electronically (e.g., based on a collection of digital photos) a home inventory or inventory of other types of insured property.

In some embodiments, underwriting insights may be determined based on pictures and/or other information provided by a customer (e.g., via a mobile device) in a game context (e.g., in exchange for points or other game rewards).

In accordance with some embodiments of the present invention, one or more systems, apparatus, methods, articles of manufacture, and/or (transitory or non-transitory) computer readable media (e.g., a non-transitory computer readable memory storing instructions for directing a processor) provide for one or more of: (i) receiving a customer data item relating to an insurance policy and/or (ii) in exchange for the received customer data item, providing to the customer at least one game reward, in which the game reward does not include an adjustment to an insurance premium. In some embodiments, at least one function or step may be performed via a user interface (e.g., presented via a display of a mobile device or other type of computing device).

In accordance with some embodiments of the present invention, one or more systems, apparatus, methods, articles of manufacture, and/or computer readable media provide for one or more of: (i) receiving a digital image (e.g., a digital picture or video) relating to an insurance policy; (ii) in exchange for the received digital image, providing to the customer at least one game reward; and/or (iii) integrating the received digital image into a communication from an insurer to the customer (e.g., a welcome letter, a declarations document for an insurance policy, an explanation of an insurance premium).

In accordance with some embodiments of the present invention, one or more systems, apparatus, methods, articles of manufacture, and/or computer readable media allow for a customer of an insurer to record, display, share, and/or organize a plurality of audio files, video files, and/or other types of media files (e.g., on a camera-enabled mobile device and/or via a server-based photo sharing service).

In accordance with some embodiments, a game system incorporating one or more of the features described in this disclosure may be integrated with web and/or mobile platforms.

In some embodiments, customer-provided data items may be related to, for example, insurance events such as, without limitation, a home, belongings, home improvements, new car purchase or new car shopping, and/or a student's report card.

As used in this disclosure, a “game reward” may include, for example, virtual badges, points, monetary and/or non-monetary prizes, downloadable content, unlocked content, in-game goods and/or options (e.g., avatars, avatar customization options, camera filters), bonus tasks (e.g., for additional points on completion), products, services, tickets, or the like. In some embodiments, game rewards may be earned, for example, for the collection of and/or transmission to an insurer of each item of information (e.g., a picture) about one or more different types of events (e.g., a home improvement). In some embodiments, a progress bar, percentage value, or other type of representation may be used to indicate a customer's current point total and/or progress toward a predetermined point goal (e.g., 80% toward receiving a pair of tickets to a sporting event).

As used in this disclosure, the term “customer” may generally refer to any type, quantity, and or manner of entity with or for which policy information, premium information, and/or game reward information may be determined in accordance with one or more described embodiments. A customer may comprise an individual or personal insurance policy holder, for example, and/or may comprise an individual, family, and/or other entity that seeks to price and/or obtain an insurance and/or other underwriting policy. A customer may have an existing business relationship with other entities described herein, such as an insurance company for example, or may not yet have such a relationship—i.e., a customer may comprise a potential customer.

As used in this disclosure, “computing device” may refer to, without limitation, one or more personal computers, laptop computers, set-top boxes, cable boxes, network storage devices, server computers, media servers, automatic teller machines (ATM), kiosks, personal media devices, communications devices, display devices, financial transaction systems, vehicle or dashboard computer systems, diagnostic, telematics, and/or monitoring devices for automobiles and/or other vehicles (e.g., IntelliDrive® telematics device by The Travelers Indemnity Company), televisions, stereo systems, video gaming systems, gaming consoles, cameras, video cameras, MP3 players, mobile devices, mobile telephones, cellular telephones, GPS navigation devices, smartphones, tablet computers, portable video players, satellite media players, satellite telephones, wireless communications devices, and/or personal digital assistants (PDA).

As used in this disclosure, “mobile device” and “portable device” may refer to, without limitation, a handheld computer, a wearable computer, a personal digital assistant, a cellular telephone, a network appliance, a camera, a smartphone, a network base station, a media player, a navigation device, a game console, a tablet computer, a laptop computer, or any combination of any two or more of such computing devices.

According to some embodiments, a user device may comprise one or more mobile devices, including but not limited to mobile telephones, cellular telephones, laptop computers, GPS navigation devices, smartphones such as a BLACKBERRY, PALM, WINDOWS 7, IPHONE, GALAXY NEXUS, or DROID phone, tablet computers such as an IPAD by APPLE, SLATE by HP, IDEAPAD by LENOVO, XOOM by MOTOROLA, KINDLE FIRE HD by AMAZON, NOTE II by SAMSUNG, or NEXUS 7 by GOOGLE, and other types of handheld, wearable and/or portable computing devices. Some type of users may find it beneficial to provide data items using a mobile device controlled in accordance with one or more of the embodiments described in this disclosure. In one example, a mobile device may comprise a smartphone. Other types of computing devices are discussed in this disclosure, and still others suitable for various embodiments will be apparent to those of ordinary skill in light of this disclosure.

It should be understood that the embodiments described herein are not limited to use with mobile devices (although some preferred embodiments are described with reference to such devices, for ease of understanding), but are equally applicable to any network device or other computing device, such as a personal desktop computer with a browser application and Internet access (e.g., in a user's home or office). Any embodiments described with reference to a mobile device in this disclosure should be understood to be equally applicable to any such other types of computing device, as deemed appropriate for any particular implementation(s).

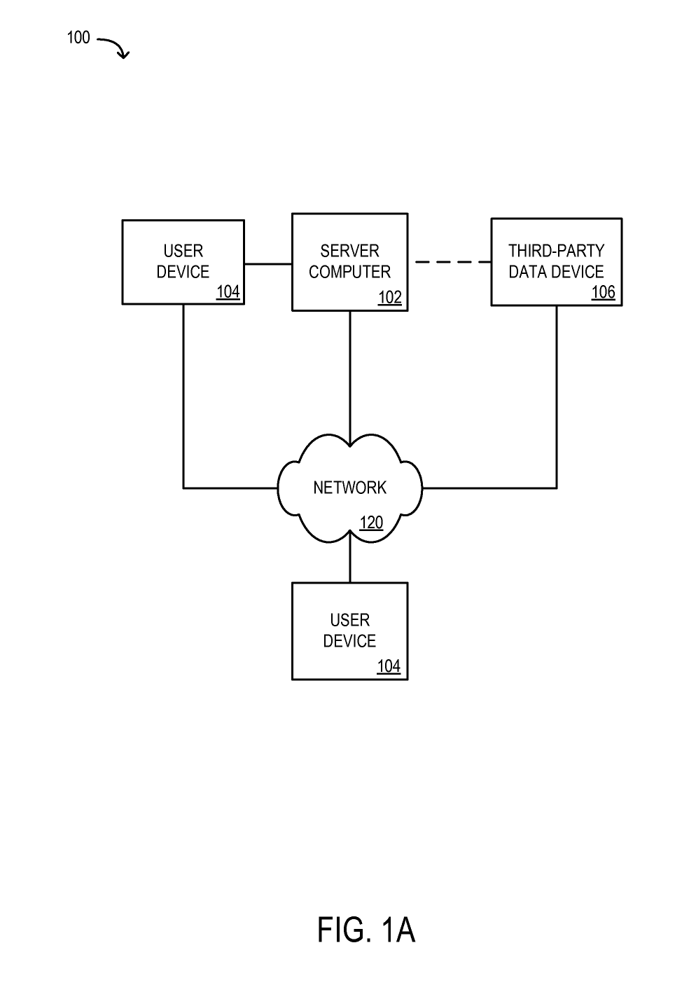

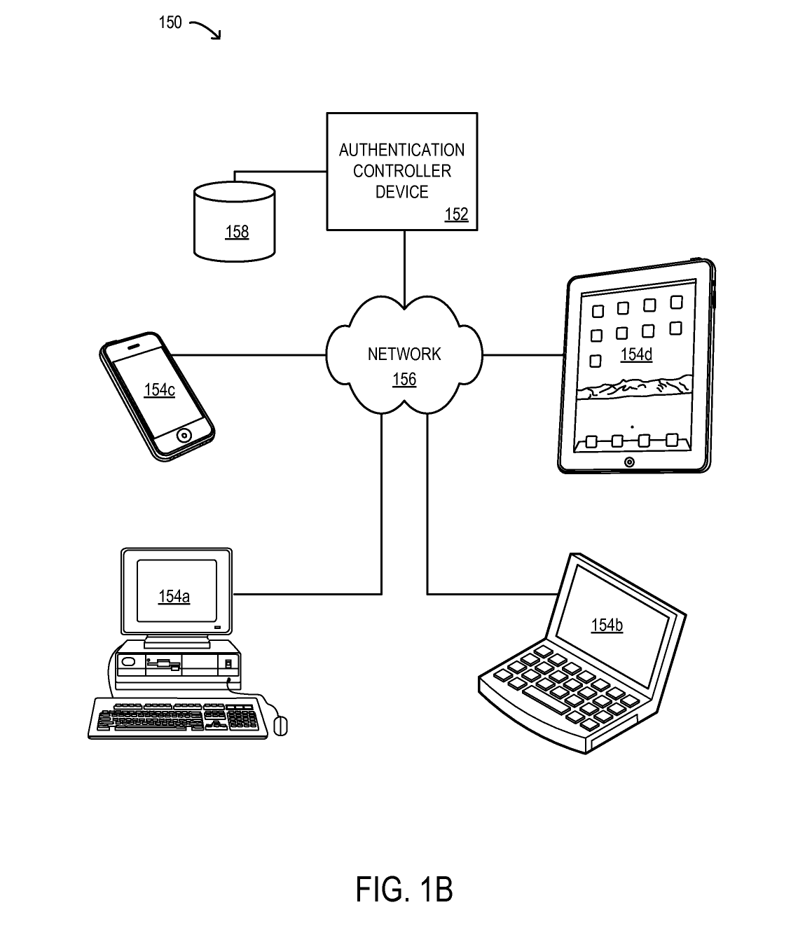

FIG. 1A depicts a block diagram of an example system 100 according to some embodiments. The system 100 may comprise one or more user devices 104 in communication with a controller or server computer 102 (that may also be or comprise a user device, in accordance with some embodiments) via a network 120. Typically a processor (e.g., one or more microprocessors, one or more microcontrollers, one or more digital signal processors) of a user device 104 or server computer 102 will receive instructions (e.g., from a memory or like device), execute those instructions, and perform one or more processes defined by those instructions. Instructions may be embodied, for example, in one or more computer programs and/or one or more scripts.

In some embodiments a server computer 102 and/or one or more of the user devices 104 stores and/or has access to information useful for performing one or more functions described in this disclosure. Such information may include one or more of: (i) insurance data, such as policy data and/or underwriting rules; (ii) customer data, such as customer-provided data relating to use of, modification to, and/or current state of insured property; and (iii) game data, such as information about a customer's game profile, rewards earned (e.g., badges earned, points earned), leaderboard rank, and/or available rewards.

According to some embodiments, any or all of such data may be stored by or provided via one or more optional third-party data devices 106 of system 100. A third-party data device 106 may comprise, for example, an external hard drive or flash drive connected to a server computer 102, a remote third-party computer system for storing and serving data for use in performing one or more functions described in this disclosure, or a combination of such remote and/or local data devices. In one embodiment, one or more companies and/or end users may subscribe to or otherwise purchase data (e.g., game data) from a third party and receive the data via the third-party data device 106.

In some embodiments, the server computer 102 may comprise one or more electronic and/or computerized controller devices such as computer servers communicatively coupled to interface with the user devices 104 and/or third-party devices 106 (directly and/or indirectly). The server computer 102 may, for example, comprise PowerEdge™ M910 blade servers manufactured by Dell, Inc. of Round Rock, Tex. which may include one or more Eight-Core Intel® Xeon® 7500 Series electronic processing devices. According to some embodiments, the server computer 102 may be located remote from the user devices 104. The server computer 102 may also or alternatively comprise a plurality of electronic processing devices located at one or more various sites and/or locations.

According to some embodiments, the server computer 102 may store and/or execute specially programmed instructions to operate in accordance with one or more embodiments described in this disclosure. The server computer 102 may, for example, execute one or more programs that facilitate receiving digital photos or other customer data items from users and/or providing indications of game rewards to users via the network 120.

In some embodiments, a user device 104 may comprise a desktop computer (e.g., a Dell OptiPlex™ desktop by Dell, Inc.) or a workstation computer (e.g., a Dell Precision™ workstation by Dell Inc.), and/or a mobile or portable computing device such as a smartphone (e.g., the IPHONE or IPAD manufactured by APPLE, the BLACKBERRY manufactured by RESEARCH IN MOTION, the PRE manufactured by PALM or the DROID manufactured by MOTOROLA), a PDA, cellular telephone, laptop (e.g., a Dell Latitude™ by Dell Inc.) or other portable computing device, and an application for receiving customer information and/or indicating game rewards is stored locally on the user device 104, which may access information (e.g., game data) stored on, or provided via, the server computer 102. In another embodiment, the server computer 102 may store some or all of the program instructions for receiving customer information and/or indicating game rewards, and the user device 104 may execute the application remotely via the network 120 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices (e.g., a desktop computer with a stand-alone application) without a central authority. In such an embodiment, any functions described in this disclosure as performed by a server computer and/or data described as stored on a server computer may instead be performed by or stored on one or more such devices, such as a mobile device or table computer. Additional ways of distributing information and program instructions among one or more user devices 104 and/or server computers 102 will be readily understood by one skilled in the art upon contemplation of the present disclosure.

FIG. 1B depicts a block diagram of an example system 150 according to some embodiments. The system 150 may comprise one or more user devices 154a-d in communication with a controller device 152 via a network 156. According to some embodiments, the controller device 154 may be in communication with one or more databases 158.

In some embodiments, the controller device 152 may comprise one or more electronic and/or computerized controller devices such as computer servers communicatively coupled to interface with the user devices 154a-d (directly and/or indirectly). The controller device 152 may, for example, comprise one or more devices as discussed with respect to server computer 102. According to some embodiments, the controller device 152 may be located remote from the user devices 154a-d. The controller device 152 may also or alternatively comprise a plurality of electronic processing devices located at one or more various sites and/or locations.

The user devices 154a-d, in some embodiments, may comprise any types or configurations of mobile electronic network, user, and/or communication devices that are or become known or practicable. user devices 154a-d may, for example, comprise cellular and/or wireless telephones such as an iPhone® manufactured by Apple, Inc. of Cupertino, Calif. or Optimus™ S smart phones manufactured by La) Electronics, Inc. of San Diego, Calif., and running the Android® operating system from Google, Inc. of Mountain View, Calif. The user device 154a may, as depicted for example, comprise a personal or desktop computer (PC), the user device 154B may comprise a laptop computer, the user device 154c may comprise a smartphone, and the user device 154d may comprise a tablet computer.

Typically a processor (e.g., one or more microprocessors, one or more microcontrollers, one or more digital signal processors) of a user device 154a-d or controller device 152 will receive specially programmed instructions (e.g., from a memory or like device), execute those instructions, and perform one or more processes defined by those instructions. Instructions may be embodied for example, in one or more computer programs and/or one or more scripts.

In some embodiments a controller device 152 and/or one or more of the user devices 154a-d stores and/or has access to data useful for providing one or more functions described in this disclosure, in a manner similar to that described with respect to system 100.

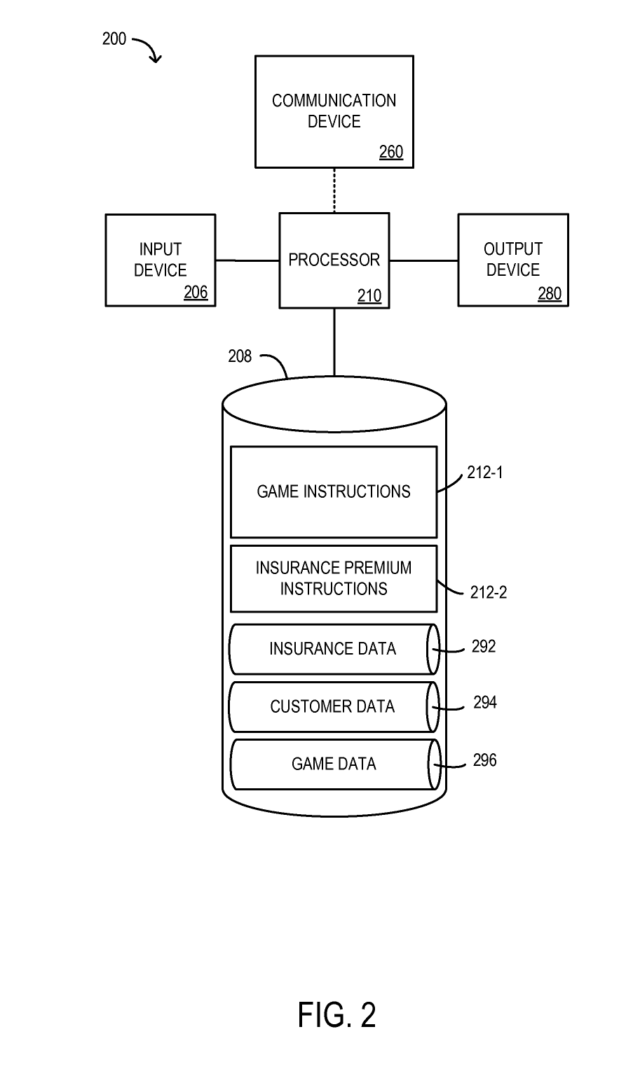

Turning to FIG. 2, a block diagram of an apparatus 200 according to some embodiments is shown. In some embodiments, the apparatus 200 may be similar in configuration and/or functionality to any of the user devices 104, server computer 102 and/or third-party data device 106 of FIG. 1A; and/or any of the controller device 152 and/or user devices 154a-d of FIG. 1B. The apparatus 200 may, for example, execute, process, facilitate, and/or otherwise be associated with any of the example processes described in conjunction with any of the flowcharts in this disclosure.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described in this disclosure.

According to some embodiments, the processor 210 may be or include any type, quantity, and/or configuration of processor that is or becomes known. The processor 210 may comprise, for example, an Intel® IXP 2800 network processor or an Intel® XEON™ processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 200 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a physical and/or virtual keyboard that allows an operator of the apparatus 200 to interface with the apparatus 200 (e.g., such as to enter data or compose an electronic message). The input device 206 may comprise, for example, one or more of a pointer device (e.g., a mouse), a camera, and/or a headphone jack. Input device 206 may include one or more of a keypad, touch screen, or other suitable tactile input device. Input device 206 may include a microphone comprising a transducer adapted to provide audible input of a signal that may be transmitted (e.g., to the processor 210 via an appropriate communications link) and/or an accelerometer or other device configured to detect movement of the device.

The output device 280 may, according to some embodiments, comprise a display screen and/or other practicable output component and/or device. The output device 280 may, for example, provide an indication of a game reward (e.g., display a goal progress meter) to a user. Output device 280 may include one or more speakers comprising a transducer adapted to provide audible output based on a signal received (e.g., via processor 210).

According to some embodiments, the input device 206 and/or the output device 280 may comprise and/or be embodied in a single device, such as a touch-screen display.

In some embodiments, the communication device 260 may comprise any type or configuration of communication device that is or becomes known or practicable. The communication device 260 may, for example, comprise a network interface card (N IC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals to a server in communication with a plurality of handheld, mobile and/or telephone devices. According to some embodiments, the communication device 260 may also or alternatively be coupled to the processor 210.

Communication device 260 may include, for example, a receiver and a transmitter configured to communicate via signals according to one or more suitable data and/or voice communication systems. In some embodiments, the communication device 260 may comprise an IR, RF, Bluetooth™, and/or Wi-Fi® network device coupled to facilitate communications between the processor 210 and another device (such as one or more mobile devices, server computers, central controllers, and/or third-party data devices). For example, communication device 260 may communicate voice and/or data over mobile telephone networks such as GSM, CDMA, CDMA2000, EDGE or UMTS. Alternatively, or in addition, communication device 260 may include receiver/transmitters for data networks including, for example, any IEEE 802.x network such as WiFi or Bluetooth™.

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 208 may, according to some embodiments, store game instructions 212-1 (e.g., as non-transitory computer-readable software code), insurance premium instructions 212-2, insurance data 292, customer data 294, and/or game data 296. In some embodiments, the game instructions 212-1 may be utilized by the processor 210 to provide output information via the output device 280 and/or the communication device 260 (e.g., via the user devices 104 and/or 154a-d of FIG. 1A and FIG. 1B, respectively).

According to some embodiments, game instructions 212-1 may be operable to cause the processor 210 to process customer data 294 and/or game data 296 as described in this disclosure, for example, to determine at least one task for a customer to perform, receive insurance information and/or information about a completed task (e.g., via a user's mobile device), and/or transmit information about one or more game rewards.

According to some embodiments, insurance premium instructions 212-2 may be operable to cause the processor 210 to process customer data 294 and/or insurance data 292 as described in this disclosure.

According to some embodiments, insurance premium adjustments may not be implemented and, accordingly, insurance premium instructions 212-2 may not be required.

Any or all of the exemplary instructions and data types and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

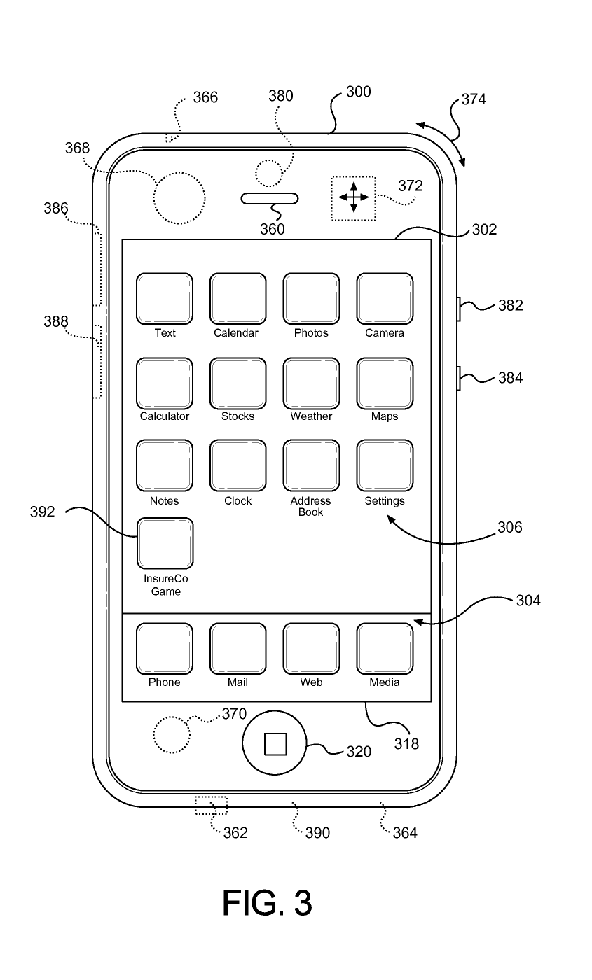

Turning to FIG. 3, a block diagram of an example mobile device 300 according to some embodiments is shown. In some embodiments, the mobile device 300 comprises a touch-sensitive display 302. The touch-sensitive display may be implemented with liquid crystal display (LCD) technology, light emitting polymer display (LPD) technology, or some other display technology. The touch-sensitive display 302 may be sensitive to haptic and/or tactile contact with a user. In some embodiments, the touch-sensitive display 302 may comprise a multi-touch-sensitive display that can, for example, process multiple simultaneous touch points, including processing data related to the pressure, degree, and/or position of each touch point. Such processing facilities gestures and interactions with multiple fingers, chording, and other interactions. Alternately or in addition, other touch-sensitive display technologies may be used, such as, without limitation, a display in which contact is made using a stylus or other pointing device.

In some embodiments, the mobile device 300 may be adapted to display one or more graphical user interfaces on a display (e.g., touch-sensitive display 302) for providing the user access to various system objects and/or for conveying information to the user. In some embodiments, the graphical user interface may include one or more display objects 304, 306, such as icons or other graphic representations of respective system objects. Some examples of system objects include, without limitation, device functions, applications, windows, files, alerts, events, or other identifiable system objects.

In some embodiments, the mobile device 300 may implement multiple device functionalities, such as a telephony device, an e-mail device, a network data communication device, a Wi-Fi base station device (not shown), and a media processing device. In some embodiments, particular display objects 304 may be displayed in a menu bar 318. In some embodiments, device functionalities may be accessed from a top-level graphical user interface, such as the graphical user interface illustrated in FIG. 3. Touching one of the display objects 304 can, for example, invoke corresponding functionality. For example, touching the display object would invoke an email application on the mobile device 300 for sending email messages.

In some embodiments, the mobile device 300 may implement network distribution functionality. For example, the functionality may enable the user to take the mobile device 300 and provide access to its associated network while traveling. In particular, the mobile device 300 may extend Internet access (e.g., Wi-Fi) to other wireless devices in the vicinity. For example, mobile device 300 may be configured as a base station for one or more devices. As such, mobile device 300 may grant or deny network access to other wireless devices.

In some embodiments, upon invocation of device functionality, the graphical user interface of the mobile device 300 changes, or is augmented or replaced with another user interface or user interface elements, to facilitate user access to particular functions associated with the corresponding device functionality. For example, in response to a user touching a phone object, the graphical user interface of the touch-sensitive display 302 may present display objects related to various phone functions; likewise, touching of an email object may cause the graphical user interface to present display objects related to various e-mail functions; touching a Web object may cause the graphical user interface to present display objects related to various Web-surfing functions; and touching a media player object may cause the graphical user interface to present display objects related to various media processing functions.

In some embodiments, the top-level graphical user interface environment or state of FIG. 3 may be restored by pressing a button 320 of the mobile device 300. In some embodiments, each corresponding device functionality may have corresponding “home” display objects displayed on the touch-sensitive display 302, and the top-level graphical user interface environment of FIG. 3 may be restored by pressing the “home” display object.

In some embodiments, the top-level graphical user interface may include display objects 306, such as a short messaging service (SMS) object and/or other type of messaging object, a calendar object, a photos object, a camera object, a calculator object, a stocks object, a weather object, a maps object, a notes object, a clock object, an address book object, a settings object, and/or one or more types of display objects having corresponding respective object environments and functionality. Touching the example “InsureCo Game” object 392 may, for example, invoke a game services environment and/or insurance customer information verification services environment, and supporting functionality, as described in this disclosure with respect to various embodiments; likewise, a selection of any of the display objects 306 may invoke a corresponding object environment and functionality.

Additional and/or different display objects may also be displayed in the graphical user interface of FIG. 3. For example, if the device 300 is functioning as a base station for other devices, one or more “connection” objects may appear in the graphical user interface to indicate the connection. In some embodiments, the display objects 306 may be configured by a user, e.g., a user may specify which display objects 306 are displayed, and/or may download additional applications or other software that provides other functionalities and corresponding display objects.

In some embodiments, the mobile device 300 may include one or more input/output (I/O) devices and/or sensor devices. For example, a speaker 360 and a microphone 362 may be included to facilitate voice-enabled functionalities, such as phone and voice mail functions. In some embodiments, an up/down button 384 for volume control of the speaker 360 and the microphone 362 may be included. The mobile device 300 may also include an on/off button 382 for a ring indicator of incoming phone calls. In some embodiments, a loud speaker 364 may be included to facilitate hands-free voice functionalities, such as speaker phone functions. An audio jack 366 may also be included for use of headphones and/or a microphone.

In some embodiments, a proximity sensor 368 may be included to facilitate the detection of the user positioning the mobile device 300 proximate to the user's ear and, in response, to disengage the touch-sensitive display 302 to prevent accidental function invocations. In some embodiments, the touch-sensitive display 302 may be turned off to conserve additional power when the mobile device 300 is proximate to the user's ear.

Other sensors may also be used. For example, in some embodiments, an ambient light sensor 370 may be utilized to facilitate adjusting the brightness of the touch-sensitive display 302. In some embodiments, an accelerometer 372 may be utilized to detect movement of the mobile device 300, as indicated by the directional arrow 374. Accordingly, display objects and/or media may be presented according to a detected orientation, e.g., portrait or landscape.

In some embodiments, the mobile device 300 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some embodiments, a positioning system (e.g., a GPS receiver) may be integrated into the mobile device 300 (e.g., embodied as a mobile type of user device, such as a tablet computer or smartphone) or provided as a separate device that may be coupled to the mobile device 300 through an interface (e.g., via communication device 260) to provide access to location-based services.

In some embodiments, a port device 390, e.g., a Universal Serial Bus (USB) port, or a docking port, or some other wired port connection, may be included in mobile device 300. The port device 390 may, for example, be utilized to establish a wired connection to other computing devices, such as other communication devices 300, network access devices, a personal computer, a printer, a display screen, or other processing devices capable of receiving and/or transmitting data. In some embodiments, the port device 390 allows the mobile device 300 to synchronize with a host device using one or more protocols, such as, for example, the TCP/IP, HTTP, UDP and any other known protocol.

The mobile device 300 may also include a camera lens and sensor 380. In some embodiments, the camera lens and sensor 380 may be located on the back surface of the mobile device 300. The camera may capture still images and/or video.

The mobile device 300 may also include one or more wireless communication subsystems, such as an 802.11b/g communication device 386, and/or a Bluetooth™ communication device 388. Other communication protocols may also be supported, including other 802.x communication protocols (e.g., WiMax, Wi-Fi, 3G), code division multiple access (CDMA), global system for mobile communications (GSM), Enhanced Data GSM Environment (EDGE), etc.

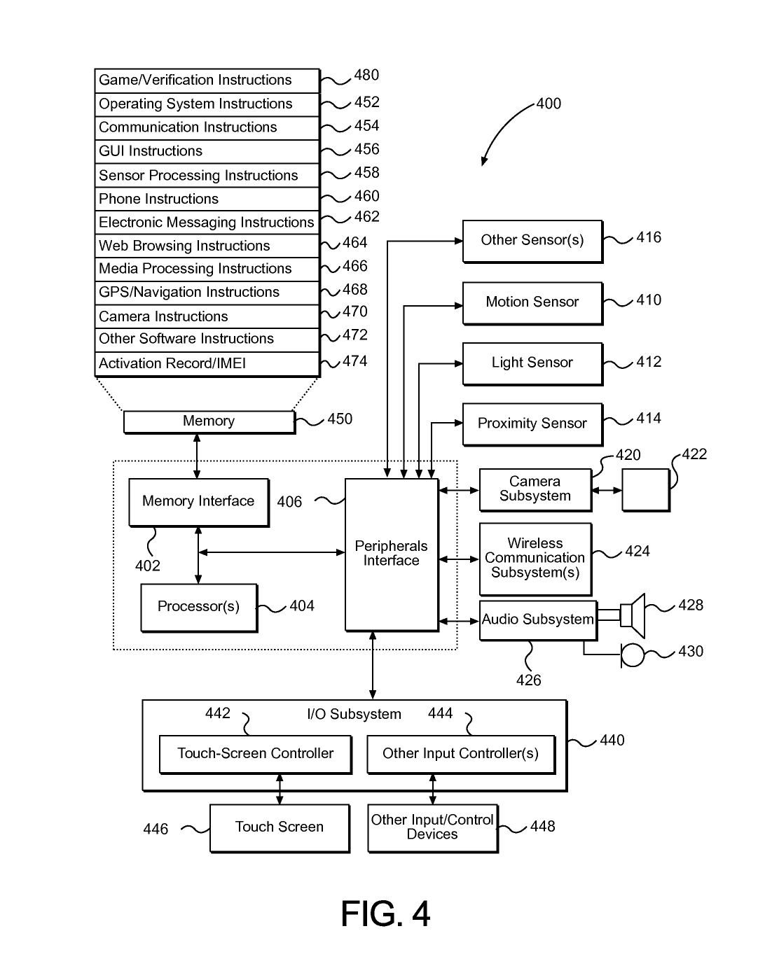

FIG. 4 is a block diagram of an example architecture for the mobile device of FIG. 3. The mobile device 300 may include a memory interface 402, one or more data processors, image processors and/or central processing units 404, and a peripherals interface 406. The memory interface 402, the one or more processors 404 and/or the peripherals interface 406 may be separate components or may be integrated in one or more integrated circuits. The various components in the mobile device 300 may be coupled by one or more communication buses or signal lines.

Sensors, devices, and subsystems may be coupled to the peripherals interface 406 to facilitate multiple functionalities. For example, a motion sensor 410, a light sensor 412, and a proximity sensor 414 may be coupled to the peripherals interface 406 to facilitate the orientation, lighting, and proximity functions described with respect to FIG. 3. Other sensors 416 may also be connected to the peripherals interface 406, such as a positioning system (e.g., GPS receiver), a temperature sensor, a biometric sensor, or other sensing device, to facilitate related functionalities.

A camera subsystem 420 and an optical sensor 422, e.g., a charged coupled device (CCD) or a complementary metal-oxide semiconductor (CMOS) optical sensor, may be utilized to facilitate camera functions, such as recording photographs and video clips.

Communication functions may be facilitated through one or more wireless communication subsystems 424, which may include radio frequency receivers and transmitters and/or optical (e.g., infrared) receivers and transmitters. The specific design and embodiment of the communication subsystem 424 may depend on the communication network(s) over which the mobile device 300 is intended to operate. For example, a mobile device 300 may include communication subsystems 424 designed to operate over a GSM network, a GPRS network, an EDGE network, a Wi-Fi or WiMax network, and a Bluetooth™ network. In particular, the wireless communication subsystems 424 may include hosting protocols such that the device 300 may be configured as a base station for other wireless devices.

An audio subsystem 426 may be coupled to a speaker 428 and a microphone 430 to facilitate voice-enabled functions, such as voice recognition, voice replication, digital recording, and telephony functions.

The I/O subsystem 440 may include a touch screen controller 442 and/or other input controller(s) 444. The touch-screen controller 442 may be coupled to a touch screen 446. The touch screen 446 and touch screen controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 446.

The other input controller(s) 444 may be coupled to other input/control devices 448, such as one or more buttons, rocker switches, thumb-wheel, infrared port, USB port, and/or a pointer device such as a stylus. The one or more buttons (not shown) may include an up/down button for volume control of the speaker 428 and/or the microphone 430.

In one embodiment, a pressing of the button for a first duration may disengage a lock of the touch screen 446; and a pressing of the button for a second duration that is longer than the first duration may turn power to the mobile device 300 on or off. The user may be able to customize a functionality of one or more of the buttons. The touch screen 446 can, for example, also be used to implement virtual or soft buttons and/or a keyboard.

In some embodiments, the mobile device 300 may present recorded audio and/or video files, such as MP3, AAC, and MPEG files. In some embodiments, the mobile device 300 may include the functionality of an MP3 player or other type of media player. Other input/output and control devices may also be used.

The memory interface 402 may be coupled to memory 450. The memory 450 may include high-speed random access memory and/or non-volatile memory, such as one or more magnetic disk storage devices, one or more optical storage devices, and/or flash memory (e.g., NAND, NOR). The memory 450 may store an operating system 452, such as Darwin, RTXC, LINUX, UNIX, OS X, WINDOWS, or an embedded operating system such as VxWorks. The operating system 452 may include instructions for handling basic system services and for performing hardware dependent tasks. In some embodiments, the operating system 452 may be a kernel (e.g., UNIX kernel).

The memory 450 may also store communication instructions 454 to facilitate communicating with one or more additional devices, one or more computers and/or one or more servers.

The memory 450 may include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GPS/Navigation instructions 468 to facilitate GPS and navigation-related processes and instructions; camera instructions 470 to facilitate camera-related processes and functions; and/or other software instructions 472 to facilitate other processes and functions, e.g., security processes and functions.

The memory 450 may also store game/verification instructions 480 for facilitating verification of insurance information via a game environment or system. In some embodiments, game/verification instructions 480 allow a customer to submit information related to an insurance product (e.g., digital pictures and/or video) and/or receive game rewards for performing tasks for the game.

The memory 450 may also store other software instructions (not shown), such as web video instructions to facilitate web video-related processes and functions; and/or web shopping instructions to facilitate web shopping-related processes and functions. In some embodiments, the media processing instructions 466 are divided into audio processing instructions and video processing instructions to facilitate audio processing-related processes and functions and video processing-related processes and functions, respectively. An activation record and International Mobile Equipment Identity (IMEI) 474 or similar hardware identifier may also be stored in memory 450.

Each of the above identified instructions and applications may correspond to a set of instructions for performing one or more functions described above. These instructions need not be implemented as separate software programs, procedures, or modules. The memory 450 may include additional instructions or fewer instructions. Furthermore, various functions of the mobile device 300 may be implemented in hardware and/or in software, including in one or more signal processing and/or application specific integrated circuits.

According to some embodiments, an insurer may present to one or more customers the potential to earn game rewards for verifying the performance by the customer of one or more tasks. For example, the insurer may offer an amount of game points, a virtual badge, a product, or some other type of game reward, in exchange for the customer satisfying a task. The customer may be required to transmit a digital picture or other evidence of performance of the task, in order to receive an associated game reward. In some embodiments, two or more tasks may be identified as a mission or project, and in some embodiments completion of a mission (e.g., completion of all or some predetermined number of associated tasks) may be associated with a game reward. In one example, Mission #1 may include Tasks A and B, and completion of each task is associated with a respective reward (e.g., 20 points for Task A, 40 points for Task B), and completion of both tasks may result in a corresponding game reward for completion of Mission #1 (e.g., tickets to a sporting event).

Some types of tasks related to automobiles may include, without limitation:
Putting a copy of registration in wallet/car
Putting insurance ID cards in glove compartment or wallet
Using paint or an indelible marker to put the vehicle identification number (VIN) under the engine hood, trunk lid, and/or on the battery
Buying a security device like a steering wheel lock or a gear shift column lock
Submitting the VIN, year, make, model, and color of the customer's car into a game application
Maintaining an adequate supply of windshield washing liquid to wash away the mud and melted snow that can severely limit visibility
Preparing for an emergency (e.g., putting in the car's trunk blankets, flares, a sack of sand for traction, shovel, windshield scraper and brush, tool kit, tow rope, booster cables, flashlight, extra batteries, and/or material for survival, such as waterproof matches to melt snow for drinking water, a first aid kit, dry clothing, and a brightly colored cloth (to tie to the antenna))
Installing snow tires or all-weather radials with adequate treads
Buying and/or installing child safety seats and/or inputting an ID number for a child safety seat into a game application (e.g., for notification in case of a recall)
Performing regular car maintenance (e.g., oil change, belt change, etc.)
Providing a copy (e.g., a picture) of a valid driver's license

Some types of tasks related to a home may include, without limitation:
Getting a Leadership in Energy and Environmental Design (LEED) home certification
Doing an inventory of a customer's property
Knowing where the main water shut-off valve for a home is located and knowing how to turn the water off
Inspecting rubber connecting hoses for dishwashers and washing machines
Replacing the rubber connecting hoses every 3-5 years, or sooner if evidence of rot appears
Resealing a flat or hot asphalt roof every three years
Having a flat or hot asphalt roof professionally checked every ten years
Inspecting and cleaning all gutters and down spouts
Labeling with a pen or permanent marker each circuit breaker, noting which location it serves
Noting the amperage of each fuse of a circuit breaker
Making sure appropriate fuses are being used and all sockets are filled
Having furnace/air conditioners professionally cleaned and serviced annually (including the filter)
Hiring a certified chimney sweep to inspect and clean creosote build-up in chimney
Ensuring all exterior doors have deadbolt locks
Placing at least one heat and smoke detector on every floor
Using detectors powered by an electrical source with a battery backup
Checking heat and smoke detector batteries every three months
Testing heat and smoke detectors every three months
Locating a fire extinguisher in the kitchen
Locating a fire extinguisher near the furnace
Instructing all household members on how to use a fire extinguisher
Installing motion-sensitive outdoor lighting
Installing central station burglar and fire alarms
Enrolling a pet dog in a training class (e.g., Canine Good Citizenship classes offered by the American Kennel Club)
Safely storing oil and/or gas (e.g., for lawn or other power equipment and/or tools) in a vented, locked area
Checking outlets for frayed wires and/or loose connections
Checking electrical decorations (e.g., holiday light displays) for potential fire hazards such as frayed wires or loose connections
Not overloading outlets, extension cords, and/or surge protectors
Checking and cleaning a home heating system to make sure it is in good working condition for the winter months (generally a job best performed by a professional)
Keeping adequate fuel reserves on hand because fuel carriers might not be able to refuel for several days during severe weather
Closing off and lowering the temperature in rooms that are not in use (e.g., but making sure there is sufficient heat to prevent the freezing of water pipes)
Insulating pipes that pass through unheated areas (e.g., a home's crawlspace or attic)
Cleaning or replace your furnace filter before the heating season begins
Cleaning the clothes dryer exhaust duct and space under the dryer in order to prevent lint from accumulating and reducing the risk of fire
Servicing snow removal equipment, and keeping ice melting compound on hand to melt ice on walkways
Removing screens from windows, and installing storm windows
Protecting your roof against heavy snow and ice loads
Keeping gutters clean and roof drains open
Inspecting washing machine hoses periodically, and replacing hoses that show signs of wear or leakage
Having your roof inspected by a professional once every few years to identify areas of potential leakage

Some embodiments provide for (i) receiving, via a game interface of a user device (e.g., a mobile app running on a smartphone or other mobile device), an image file (e.g., a digital photo) depicting an activity of a customer, the activity being related to an insurance product that comprises at least one of: a current insurance product for the customer and a potential insurance product for the customer; (ii) determining, based on the image file depicting the activity of the customer, a game reward for the customer, the game reward comprising at least one of the following: a product that is not an insurance product, a number of game points, a badge, and an adjustment to a base premium for an insurance product; (iii) storing (e.g., by a central controller device), an indication of the game reward in association with the customer; and (iv) transmitting (e.g., the user device) an indication of the game reward for presentation to the customer via the game interface.

Some embodiments provide for (i) receiving, via a game interface of a user device, information about an activity of a customer, wherein the activity is related to an insurance product that comprises at least one of: a current insurance product for the customer and a potential insurance product for the customer; (ii) determining, based on the information about the activity, a game reward for the customer, wherein the game reward does not include an adjustment to a base premium for an insurance product; (iii) storing an indication of the game reward in association with the customer; and (iv) transmitting an indication of the game reward for presentation to the customer via the game interface of the user device. In some embodiments, the information about the activity of the customer may comprise one or more of: a media file, a video file, a digital picture, an audio file, an image file, an image of property (e.g., insured property), an image of a home, an image of a vehicle, an image of the customer, an image of a family member (e.g., a good student), an indication of GPS location of a user device, an indication of a time of an activity, and/or an indication of a compass direction of a user device.

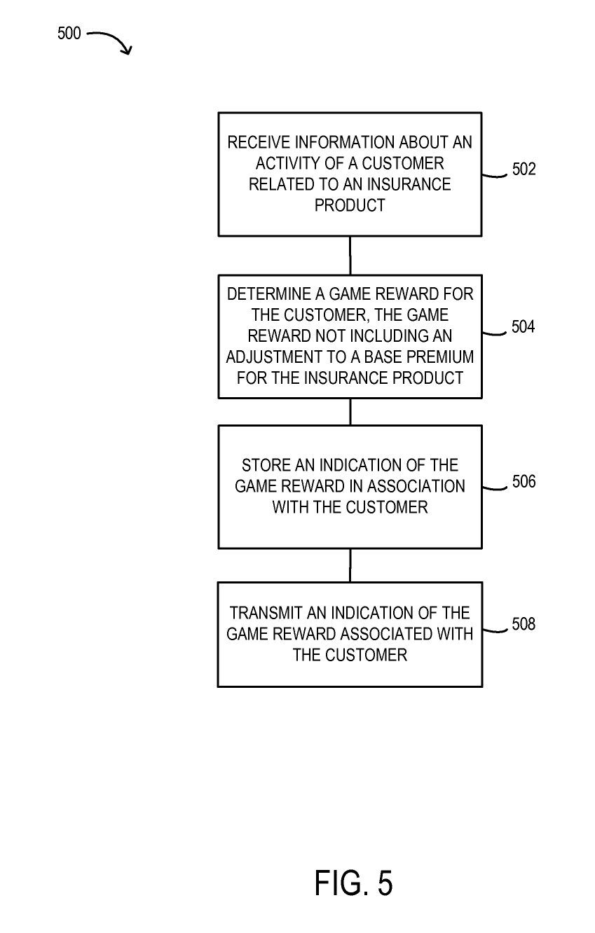

Referring now to FIG. 5, a flow diagram of a method 500 according to some embodiments is shown. The method 500 will be described herein as being performed by a user device (e.g., a desktop or laptop computer). It should be noted that although some of the steps of method 500 may be described herein as being performed by a user device while other steps are described herein as being performed by another computing device, any and all of the steps may be performed by a single computing device which may be a user device, server computer, or another computing device. Further any steps described herein as being performed by a particular computing device may, in some embodiments, be performed by a human or a different computing device as appropriate.

According to some embodiments, the method 500 may comprise receiving information about an activity of a customer related to an insurance product, at 502. Receiving information about an activity of a customer related to an insurance product may comprise receiving information via a user interface, game interface, and/or via a user device. In some embodiments, the information may comprise information input by a user in a form, dropdown menu, or other interface element, text information, audio files or input, digital image files (e.g., video and/or pictures), word processing files, and/or one or more other known types of information. Receiving an image file may comprise, for example, receiving a digital photo from a camera of a mobile device (e.g., smartphone or tablet computer), selecting an image file from a gallery or media application, or downloading an image file from an email or external source. In one embodiment, a mobile device game application allows a user to take a photo. Various types of activities or tasks related to an insurance product are described in this disclosure, including checking smoke alarms, verifying a good student report card, and the like.

According to some embodiments, receiving information about an activity of a customer may comprise deriving information from a media file, such as an audio file or digital image file, to identify information related to an insurance product and/or for use in verifying information that a customer may have indicated previously to an insurer. This may be useful, in some implementations, for verifying customer information by deriving license numbers, certificate identifiers, street addresses, GPS locations, and/or other types of identifying information. Verifying such information may comprise deriving information from a digital image, such as by reviewing an image manually and/or processing an image using optical character recognition software and/or object recognition software. For instance, in order to verify that a customer has a valid driver's license, the customer may be prompted (e.g., as a game task) to provide a photo of the customer's driver's license. In another example, an insurer may wish to verify that a customer finished a driving safety course by submitting a picture of a certificate of completion for the course. The photo may be processed (e.g., by a computing device, by an insurance professional) in order to identify a license number, certification identifier, and/or barcode in the photo. The derived license number or other type of identifying information may be used, for example, to compare with information previously received (e.g., to update customer records or identify a discrepancy) and/or to verify the identifier with another data source (e.g., by checking a license number against a state database to verify its validity). In a similar manner, deriving information from an audio file may include using voice recognition software to identify information provided in a recorded voice message (e.g., a customer's home address, telephone number, driver's license number, etc.).

The method 500 may comprise determining a game reward for the customer, the game reward not including an adjustment to a base premium for the insurance product, at 504. In some embodiments, determining the game reward comprises identifying a task or activity (e.g., a task associated with the image file) and determining the respective game reward associated with the task. In one example, a user selects a task from a selection of available tasks displayed in a mobile device game application, and the application determines the associated game reward (e.g., a number of game points). At 504, the game reward is not an insurance premium adjustment for an insurance product, though it will be understood that in some embodiments the game reward may comprise such an adjustment (e.g., a discount on an insurance premium for installing fire extinguishers).

The method 500 may comprise storing an indication of the game reward in association with the customer, at 506. For example, the indication of the number of points earned by a customer in completing a task of changing batteries in a smoke detector and verifying with a photo may be stored in a database (e.g., at the mobile device and/or at a central controller) such as game data 296. The method 500 may comprise transmitting an indication of the game reward, at 508. In one example, an indication of an earned game reward is displayed to a user via a game interface of a mobile device. In another example, the indication is transmitted to a server computer for storing in a database of game data in association with a customer.

In some embodiments, a “mission” describes a set of one or more insurance functions or tasks that a user may attempt to complete in a mobile app (e.g., a software application for a mobile device). A mission may comprise one task or more than one task, and one or more missions may be organized into one or more mission sets. Completion of a task may be rewarded with a number of game points, and completion of a mission (e.g., completing all tasks within a defined mission) makes a user eligible to earn bonus points or other types of game rewards. In some embodiments, a mission page is used to display a Risk Meter (e.g., a progress indicator, counter) that indicates a user's progress in the mobile app. The progress of the Risk Meter is based on the points the user earns in the app. Some examples of mission sets, missions, and associated tasks are provided below; other types of missions and tasks may be readily contemplated in light of this disclosure.

| Mission Set | | | |
|---|---|---|---|
| Identifier | Mission Identifier | Task List | Recurrence |
| 1 | Get Started | Take picture of nearest safety device (e.g., | No |
| | | exit, smoke detector, fire extinguisher | |
| | | Take picture of automobile VIN number | |
| | | Create user avatar | |
| 2 | Home Fire Safety | Check batteries of all smoke alarms | 3 months |
| | | Check pressure on fire extinguisher | 3 months |
| | | Clean up lint in dryer | 1 year |
| 2 | Auto Mission | Paint VIN number on engine hood | No |
| | | Paint VIN number on battery | |
| | | Take picture of trunk safety latch | |
| 2 | Good Grade | Take picture of student's good grade report | 6 months |
| 3 | Driver Training | Take picture of driver training verification | No |
| | | coupon | |
| 3 | LEED Badge | Take picture of LEED certification | No |
| 3 | Green Mission | Change light bulbs | No |
| | | Insulate pipes | |
| 3 | Pet | Take picture of user's pet | No |
| 4 | Auto Anti-Theft | Take a picture of any anti-theft device | No |
| | | Install steering wheel lock | |
| | | Install LoJack ™ | |
| 4 | Home Anti-Theft | Take picture of door deadbolt | No |
| | | Install motion sensitive lighting | |
| | | Install home security system | |
| 4 | Home Safety | Attend home safety seminar - take picture | No |
| | Seminar | of receipt | |
| 5 | Policy Details | Provide policy information | No |
| 5 | Home Exterior | Take multiple pictures of house | No |
| 5 | eDelivery | Sign up for paperless correspondence with | No |
| | | insurer | |
| 6 | Home Emergency | Set up first aid kit - take picture | No |
| | | Get flashlight - take picture | |
| | | Spare batteries - take picture | |
| 6 | Auto Emergency | Emergency shovel in car - take picture | 1 year |
| | | Set up first aid kit - take picture | No |
| | | Get flashlight - take picture | No |
| 6 | Driving Pledge | Picture of pledge against texting | No |
| | | Picture of pledge against DUI | |

In some embodiments, at least one task of each associated mission requires a user to use a camera application to take a picture to complete the task. In some embodiments, tasks of a mission may be performed in any order; in some embodiments, at least two tasks must be completed in a particular, predefined order.

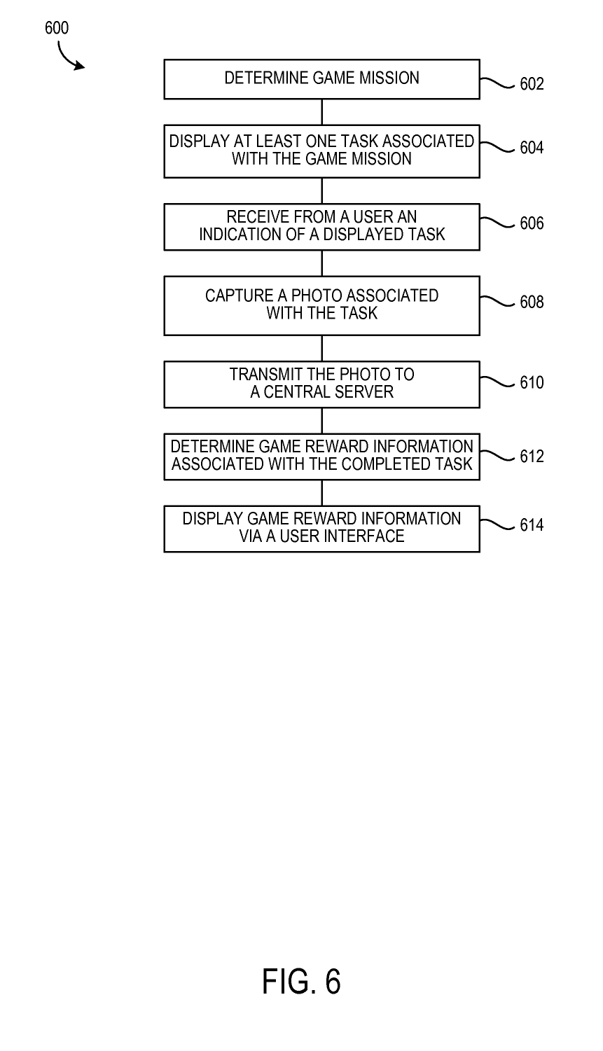

Referring now to FIG. 6, a flow diagram of a method 600 according to some embodiments is shown. For purposes of brevity, the method 600 will be described herein as being performed by a user device (e.g., a smartphone, a desktop computer). It should be noted that although some of the steps of method 600 may be described herein as being performed by a user device while other steps are described herein as being performed by another computing device, any and all of the steps may be performed by a single computing device which may be a user device, server computer, third party data device, or another computing device. Further, any steps described herein as being performed by a particular computing device may be performed by a human or another computing device as appropriate.

According to some embodiments, the method 600 may comprise determining a game mission, at 602, and displaying at least one task associated with the game mission, at 604. In some embodiments, determining a game mission and/or task may comprise looking up available missions and/or tasks in a database (e.g., game data 296).

The method 600 may comprise receiving from a user an indication of a displayed task, at 606. For example, a user may select, via a smartphone's touchscreen, a displayed task. At 608, a photo associated with the task is captured. For example, a mobile device game application may provide the functionality for a user to take a picture related to activity performed to complete a task (e.g., a picture of a VIN painted on a car battery). At 610, the photo is transmitted to a central server (e.g., from a smartphone or other mobile device). For example, the photo may be transmitted over a communications network to an insurer's game server for use in verifying completion of a task, determination of insurance premium, and/or incorporation in insurance-related documentation. At 612, game reward information associated with the completed task is determined (e.g., a number of game points) and the game reward information is displayed via a user interface (e.g., a smartphone's display screen), at 614. For example, the game reward associated with completion of the task may include a reward for a completed task and/or a reward for a mission completed with the task.

Any or all of methods 500 and 600, and other methods described in this disclosure, may involve one or more interface(s). One or more of such methods may include, in some embodiments, providing an interface by and/or through which a user may (i) receive an indication of one or more types of information to submit (e.g., one or more tasks to perform, types of pictures to submit), (ii) submit one or more types of information (e.g. upload a photo), and/or (iii) receive or otherwise be presented with an indication of at least one game reward (e.g., have displayed to the user a badge for completing a task). Although certain types of information are illustrated in the example interfaces, those skilled in the art will understand that the interfaces may be modified in order to provide for additional types of information and/or to remove some of the illustrated types of information, as deemed desirable for a particular implementation.

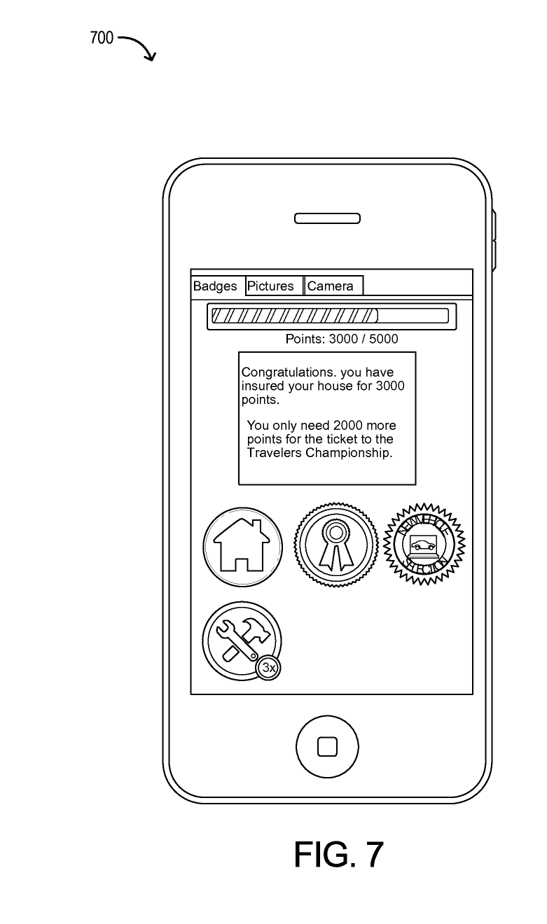

FIG. 7 illustrates an example interface 700 for a mobile device game application for displaying game rewards earned in a game for verifying insurance-related information. In the example, a number of different badges are represented, and a progress bar indicates the number of points earned toward a total points goal.

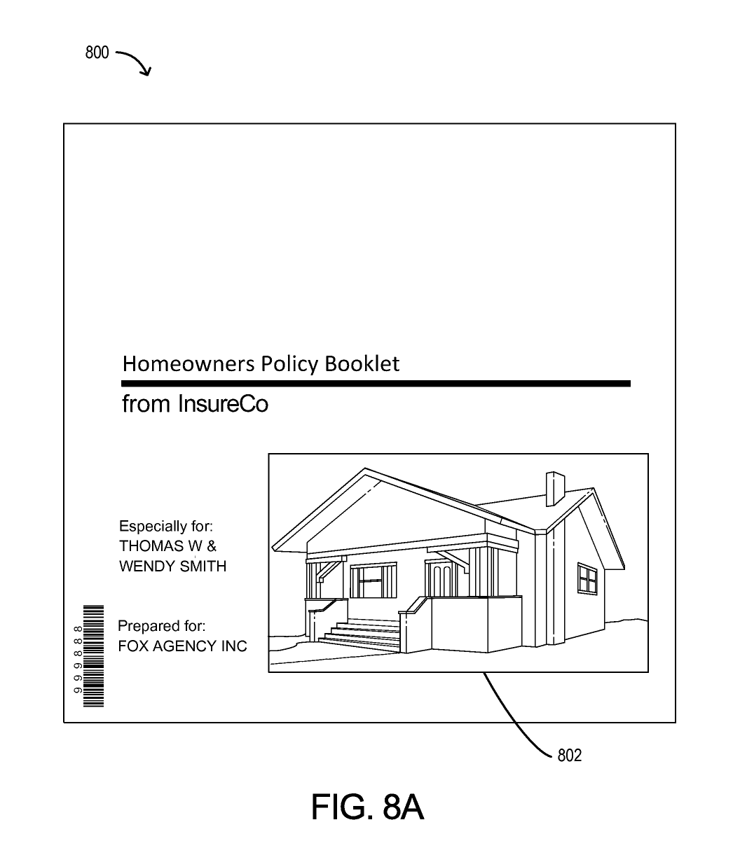

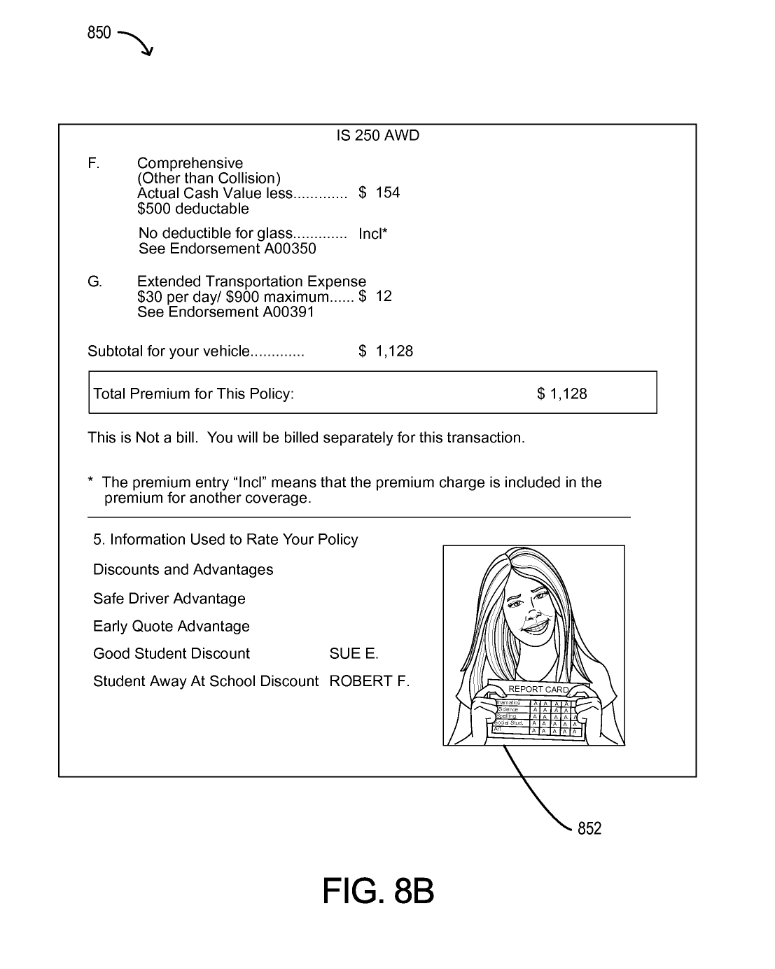

FIG. 8A illustrates an example policy booklet 800 incorporating a photo of a house 802 submitted by a user via a game system. In some embodiments, one or more digital image files may be incorporated by an insurer in insurance-related correspondence and/or documentation, allowing for customization based on content submitted by the customer. Similarly, FIG. 8B illustrates an example policy booklet 850 incorporating a photo of a good grade report 852 in proximity to a description of the good student discount for the policy.

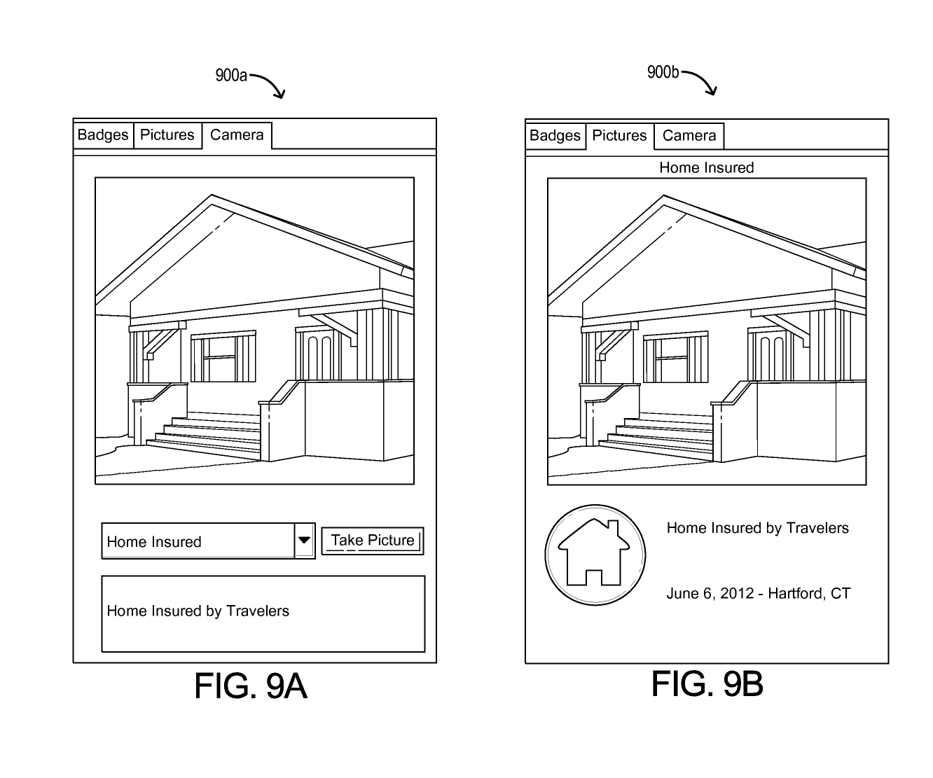

FIG. 9A illustrates an example interface 900a prompting a user to take the displayed picture of a home using a camera of a mobile device. FIG. 9B illustrates an example interface 900b indicating successful completion of the task of taking a photo of the user's home, and displaying the corresponding badge earned as a game reward.

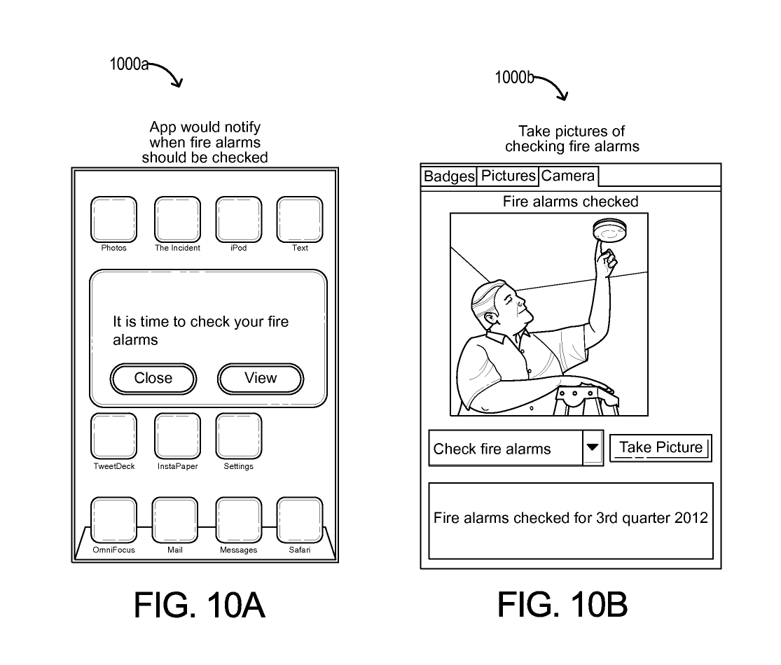

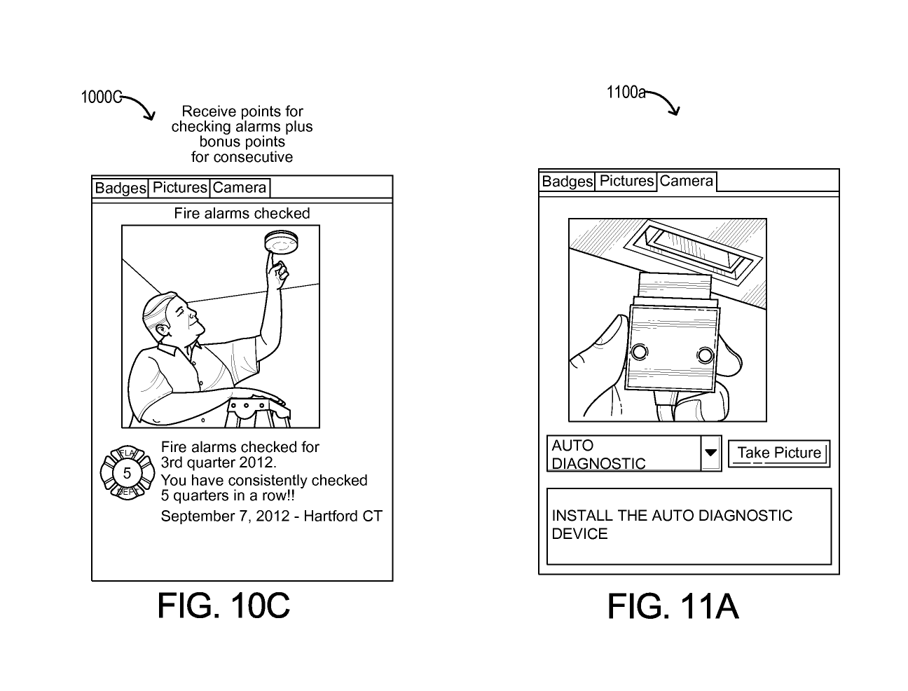

FIG. 10A illustrates an example interface 1000a prompting a user with a notification to perform a task of checking a home's fire alarms. FIG. 10B illustrates an example interface 1000b prompting a user to take the displayed picture of checking fire alarms using a camera of a mobile device, and a corresponding description of the picture. FIG. 10C illustrates an example interface 1000c indicating successful completion of the task of checking fire alarms, and displaying the corresponding badge earned as a game reward.

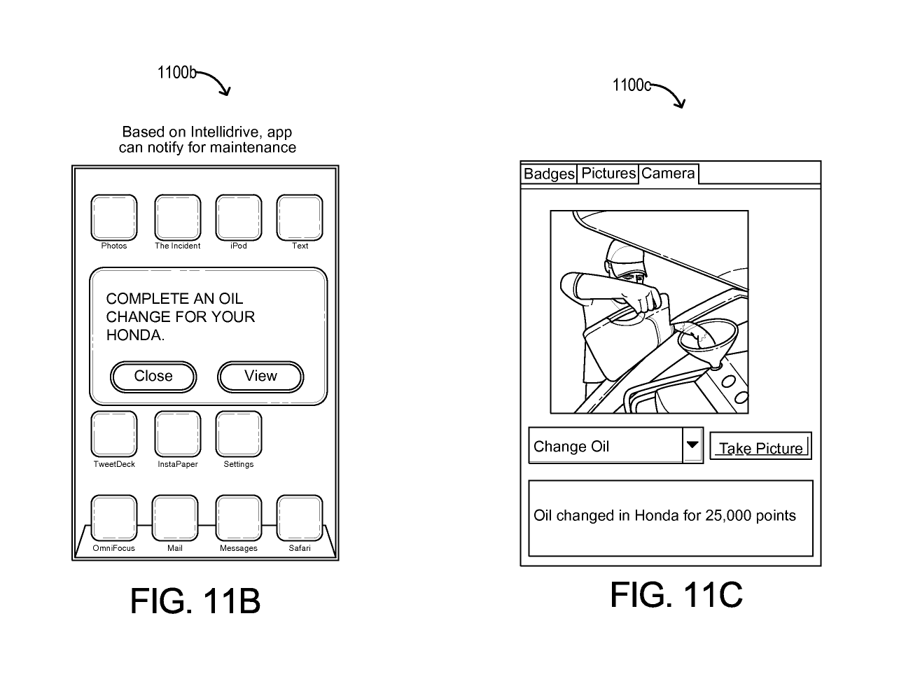

FIG. 11A illustrates an example interface 1100a prompting a user to perform a task of installing a diagnostic or monitoring device in an automobile (e.g., an insured car). FIG. 11B illustrates an example interface 1100b prompting a user with a notification to perform an oil change on a vehicle. FIG. 11C illustrates an example interface 1100c prompting a user to take the displayed picture of the vehicle's oil being changed.

Although some of the examples provided in this disclosure may be discussed in the context of example mobile devices (e.g., smartphones and/or tablet computers) and communications systems for such devices, according to one or more embodiments, processes for verifying insurance information may be used in association with various other types of computing devices.

As discussed in this disclosure, some embodiments may include features, tasks, and/or functions for motivating a customer to make proactive behavior changes (e.g., to protect the customer's assets, to reduce risk of property loss or injury). In one example, tasks required in a game may reduce one or more risks. For instance, a task may require a user to create an evacuation plan and distribute it to one or more other people. By taking a picture of the plan and emailing it or otherwise forwarding the plan to others, users may reduce certain risks.

According to some embodiments, a mobile game application may include one or more instructions for how to perform one or more kinds of tasks. In one example, the application may include video, audio, and/or text instructions. Alternatively or in addition, the application may provide hyperlinks to such instructions (e.g., available over the Internet or other network) or otherwise allow a user to access content for explaining how to perform a task, play a game, redeem prizes, and the like.

According to some embodiments, a measure of a number of points accumulated by a customer may be referred to as an “asset safety quotient” and/or may be represented via a “risk meter” indicating a customer's progress toward a total points goal or completion of a mission (e.g., based on successful completion of one or more tasks).

According to some embodiments, a user may create a customizable avatar for use within a mobile app. The avatar may be customizable on one or more parameters (e.g., attire, skin color, and hair color).

In some embodiments, badges and other game rewards that a user may earn by completing missions may be displayed in a virtual trophy case.

According to some embodiments, whenever a user achieves a badge or unlocks a game reward, a success notification page may be overlaid on top of a currently displaying page, in order to draw the user's attention to the achievement. Other examples of notifications about status updates that may be useful in conveying information about user achievements will be readily understood in light of this disclosure.

According to some embodiments, a user may access a leaderboard within a mobile app. The leaderboard may comprise, for example, a server hosted page displaying users' relative positions or rankings based on a number of earned points, badges, and/or other types of game rewards. In one example, a leaderboard may display a user's avatar, the user's name, a number of associated game points earned by the user, and/or an indication of at least one recently completed task.

According to some embodiments, a user may be notified via a mobile app that a recurring mission or mission is available and/or a task is due to be completed.

According to some embodiments, a number of points of other game reward that a user may earn for completing a task may be determined based on a determined or estimated benefit to an insurer for completion of the task, a determined or estimated cost to complete the task, and/or a determined difficulty of the task. In one example, a task may have an associated business value rating (e.g., a rating from 1 to 10), a difficulty rating, and/or a cost rating. According to some embodiments, bonus points for completing all or some predetermined number of tasks in a mission may be determined based on a logarithmic progression (e.g., Mission bonus points=ln(mission number*100)*10).

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (set forth at the beginning of the first page of this disclosure) nor the Abstract (set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The phrase “based on” does not mean “based only on”, unless expressly specified otherwise. In other words, the phrase “based on” describes both “based only on” and “based at least on”.

As used in this disclosure, a “user” may generally refer to any individual and/or entity that operates a user device.

Some embodiments may be associated with a “user device” or a “network device”. As used in this disclosure, the terms “user device” and “network device” may be used interchangeably and may generally refer to any device that can communicate via a network. Examples of user or network devices include a personal computer (PC), a workstation, a server, a printer, a scanner, a facsimile machine, a copier, a personal digital assistant (PDA), a storage device (e.g., a disk drive), a hub, a router, a switch, and a modem, a video game console, or a wireless phone. User and network devices may comprise one or more communication or network components.

Some embodiments may be associated with a “network” or a “communication network”. As used in this disclosure, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. In some embodiments, networks may be hard-wired, wireless, virtual, neural, and/or any other configuration or type of network that is or becomes known. Networks may comprise any number of computers and/or other types of devices in communication with one another, directly or indirectly, via a wired or wireless medium such as the Internet, LAN, WAN or Ethernet (or IEEE 802.3), Token Ring, RF, cable TV, satellite links, or via any appropriate communications means or combination of communications means. In some embodiments, a network may include one or more wired and/or wireless networks operated in accordance with any communication standard or protocol that is or becomes known or practicable. Exemplary protocols for network communications include but are not limited to: the Fast Ethernet LAN transmission standard 802.3-2002® published by the Institute of Electrical and Electronics Engineers (IEEE), Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Communication between and/or among devices may be encrypted to ensure privacy and/or prevent fraud in any one or more of a variety of ways well known in the art.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described in this disclosure are associated with an “indication”. The term “indication” may be used to refer to any indicia and/or other information indicative of or associated with a subject, item, entity, and/or other object and/or idea. As used in this disclosure, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

“Determining” something may be performed in a variety of manners and therefore the term “determining” (and like terms) includes calculating, computing, deriving, looking up (e.g., in a table, database or data structure), ascertaining, recognizing, and the like.

A “processor” means any one or more microprocessors, Central Processing Unit (CPU) devices, computing devices, microcontrollers, digital signal processors, or like devices. Examples of processors include, without limitation, INTEL's PENTIUM, AMD's ATHLON, or APPLE's A6 processor.

When a single device or article is described in this disclosure, more than one device or article (whether or not they cooperate) may alternatively be used in place of the single device or article that is described. Accordingly, the functionality that is described as being possessed by a device may alternatively be possessed by more than one device or article (whether or not they cooperate). Where more than one device or article is described in this disclosure (whether or not they cooperate), a single device or article may alternatively be used in place of the more than one device or article that is described. For example, a plurality of computer-based devices may be substituted with a single computer-based device. Accordingly, functionality that is described as being possessed by more than one device or article may alternatively be possessed by a single device or article. The functionality and/or the features of a single device that is described may be alternatively embodied by one or more other devices that are described but are not explicitly described as having such functionality and/or features. Thus, other embodiments need not include the described device itself, but rather may include the one or more other devices that would, in those other embodiments, have such functionality/features.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

It will be readily apparent that the various methods and algorithms described in this disclosure may be implemented by, e.g., appropriately- and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

Accordingly, a description of a process likewise describes at least one apparatus for performing the process, and likewise describes at least one computer-readable medium and/or computer-readable memory for performing the process. The apparatus that performs a described process may include components and/or devices (e.g., a processor, input and output devices) appropriate to perform the process. A computer-readable medium may store program elements and/or instructions appropriate to perform a described method.

The term “computer-readable medium” refers to any medium that participates in providing data (e.g., instructions or other information) that may be read by a computer, a processor, or a like device. Various forms of computer-readable media may be involved in carrying data, including sequences of instructions, to a processor. For example, sequences of instruction (i) may be delivered from RAM to a processor, (ii) may be carried over a wireless transmission medium, and/or (iii) may be formatted according to any one or more of various known formats, standards, or protocols (some examples of which are described in this disclosure with respect to communication networks).

Computer-readable media may take many forms, including but not limited to, non-volatile media, volatile media, and transmission media. Non-volatile media may include, for example, optical or magnetic disks and other types of persistent memory. Volatile media may include, for example, DRAM, which typically constitutes the main memory for a computing device. Transmission media may include, for example, coaxial cables, copper wire, and fiber optics, including the wires that comprise a system bus coupled to the processor. Transmission media may include or convey acoustic waves, light waves, and electromagnetic emissions, such as those generated during RF and IR data communications. Common forms of computer-readable media include, for example, a floppy disk, a flexible disk, a hard disk, magnetic tape, any other magnetic medium, a CD-ROM, DVD, any other optical medium, a punch card, paper tape, any other physical medium with patterns of holes, a RAM, a PROM, an EPROM, a FLASH-EEPROM, a Universal Serial Bus (USB) memory stick or thumb drive, a dongle, any other memory chip or cartridge, a carrier wave, or any other medium from which a computer can read.

The term “computer-readable memory” may generally refer to a subset and/or class of non-transitory computer-readable medium that does not include intangible or transitory signals, waves, waveforms, carrier waves, electromagnetic emissions, or the like. Computer-readable memory may typically include physical, non-transitory media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, USB devices, any other memory chip or cartridge, and the like.

Where databases are described, it will be understood by one of ordinary skill in the art that (i) alternative database structures to those described may be readily employed, and (ii) other memory structures besides databases may be readily employed. Any illustrations or descriptions of any sample databases presented in this disclosure are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries may be different from those described in this disclosure. Further, despite any depiction of the databases as tables, other formats (including relational databases, object-based models, hierarchical electronic file structures, and/or distributed databases) could be used to store and/or manipulate the described data. Likewise, object methods or behaviors of a database may be used to implement one or more of various processes, such as those described in this disclosure. In addition, the databases may, in a known manner, be stored locally and/or remotely from a device that accesses data in such a database. Furthermore, while unified databases may be contemplated, it is also possible that the databases may be distributed and/or duplicated amongst a variety of devices.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, via a game interface of a user device, an image file depicting an activity of a customer, wherein the activity is related to an insurance product that comprises at least one of: a current insurance product for the customer and a potential insurance product for the customer;
determining, by the user device and based on the image file depicting the activity of the customer, a game reward for the customer, wherein the game reward comprises at least one of the following:
a product that is not an insurance product,
a number of game points,
a badge, and
an adjustment to a base premium for an insurance product;
storing, by the user device, an indication of the game reward in association with the customer; and
displaying, via the game interface of the user device, an indication of the game reward for the customer.

2. The method of claim 1, further comprising:
determining at least one task to be completed for a respective game reward; and
displaying, via the game interface of the user device, an indication of the at least one task.

3. The method of claim 1, in which storing the indication of the game reward in association with the customer comprises:
transmitting an indication of the game reward to a controller device for storage in a game data database.

4. The method of claim 1, further comprising:
determining, by the user device, at least one condition associated with a game goal that is associated with a second game reward;
determining, by the user device and based on the activity of the customer, that the customer has satisfied the at least one condition associated with the game goal; and
awarding to the customer the second game reward.

5. The method of claim 4, in which the second game reward comprises bonus game points.

6. The method of claim 1, further comprising:
determining, by the user device, a total number of points associated with a second game reward;
determining, by the user device and based on the information about the activity of the customer, that the customer has accumulated at least the total number of points associated with the second game reward; and
awarding to the customer the second game reward.

7. The method of claim 1, further comprising:
presenting, via the game interface of the user device, a current total number of game points earned by the customer.

8. The method of claim 1, further comprising:
receiving, via the game interface of the user device from the customer, a description of the activity performed by the customer.

9. The method of claim 1, further comprising:
presenting, via the game interface of the user device, respective indications of a plurality of game rewards earned by the customer.

10. The method of claim 1, wherein the game reward does not comprise an adjustment to the base premium for an insurance product.

11. The method of claim 1, further comprising:
determining, based on the activity of the customer, an adjusted premium for the insurance product that is different than a base premium for the insurance product; and
providing to the customer an indication of the adjusted premium for the insurance product;

12. The method of claim 1, wherein the activity of the customer comprises a task performed by the customer.

13. The method of claim 1, wherein the activity of the customer comprises one or more of the following:
a task related to a vehicle of the customer,
a task related to a building owned by the customer,
a maintenance task related to maintenance of property of the customer,
a task related to home safety,
a task related to vehicle safety,
a task related to pool safety, and
a task related to security of property.

14. The method of claim 1, wherein the activity of the customer comprises one or more of the following:
a home improvement,
a purchase of a vehicle,
a purchase of a product for the home, and
an indication of a student report card.

15. The method of claim 1, wherein the image file comprises one or more of the following:
a video file,
a digital picture,
an image of property of the customer,
an image of a home of the customer,
an image of a vehicle of the customer,
an image of the customer,
an image of a family member of the customer,
an indication of GPS location associated with an image, and
an indication of a timestamp associated with an image.

16. An apparatus comprising:
a processor;
a game interface in communication with the processor; and
a computer readable storage device in communication with the processor, the computer readable storage device storing instructions configured to direct the processor to perform:
receiving, via the game interface, an image file depicting an activity of a customer, wherein the activity is related to an insurance product that comprises at least one of: a current insurance product for the customer and a potential insurance product for the customer;
determining, based on the image file depicting the activity of the customer, a game reward for the customer, wherein the game reward comprises at least one of the following:
a product that is not an insurance product,
a number of game points,
a badge, and
an adjustment to a base premium for an insurance product;
storing an indication of the game reward in association with the customer; and
displaying, via the game interface, an indication of the game reward for presentation to the customer.

17. The apparatus of claim 16, the instructions being configured further to direct the processor to perform:
determining at least one task to be completed for a respective game reward; and
displaying, via the game interface, an indication of the at least one task.

18. The apparatus of claim 16, in which storing the indication of the game reward in association with the customer comprises:
transmitting an indication of the game reward to a controller device for storage in a game data database.

19. The apparatus of claim 16, the instructions being configured further to direct the processor to perform:
determining at least one condition associated with a game goal that is associated with a second game reward;
determining, based on the activity of the customer, that the customer has satisfied the at least one condition associated with the game goal; and
awarding to the customer the second game reward.

20. The method of claim 19, in which the second game reward comprises bonus game points.

21. The apparatus of claim 16, the instructions being configured further to direct the processor to perform:
determining a total number of points associated with a second game reward;
determining, based on the information about the activity of the customer, that the customer has accumulated at least the total number of points associated with the second game reward; and
awarding to the customer the second game reward.

22. The apparatus of claim 16, the instructions being configured further to direct the processor to perform:
presenting, via the game interface, a current total number of game points earned by the customer.

23. The apparatus of claim 16, the instructions being configured further to direct the processor to perform:
receiving, via the game interface from the customer, a description of the activity performed by the customer.

24. The apparatus of claim 16, the instructions being configured further to direct the processor to perform:
presenting, via the game interface, respective indications of a plurality of game rewards earned by the customer.

25. The apparatus of claim 16, wherein the game reward does not comprise an adjustment to the base premium for an insurance product.

26. The apparatus of claim 16, the instructions being configured further to direct the processor to perform:
determining, based on the activity of the customer, an adjusted premium for the insurance product that is different than a base premium for the insurance product; and
providing to the customer an indication of the adjusted premium for the insurance product;
